(19) United States
(12) Patent Application Publication
(10) Pub. No.: US 2026/0011321 A1
(43) Pub. Date: Jan. 8, 2026

(54) MODEL LEARNING APPARATUS, SATISFACTION ESTIMATION APPARATUS, MODEL LEARNING METHOD, SATISFACTION ESTIMATION METHOD, AND PROGRAM

(71) Applicant: NIPPON TELEGRAPH AND TELEPHONE CORPORATION, Tokyo (JP)

(72) Inventors: Atsushi ANDO, Tokyo (JP); Yumiko MURATA, Tokyo (JP); Takeshi MORI, Tokyo (JP)

(73) Assignee: NIPPON TELEGRAPH AND TELEPHONE CORPORATION, Tokyo (JP)

(21) Appl. No.: 18/993,694

(22) PCT Filed: Jul. 19, 2022
(86) PCT No.: PCT/JP2022/028033

§ 371 Date: Jan. 13, 2025

(51) Int. Cl. G10L 15/16; G10L 15/02

(52) U.S. Cl. CPC G10L 15/16; G10L 15/02

(57) ABSTRACT

A model learning apparatus includes an utterance feature reconstruction model learning unit configured to train an utterance feature reconstruction model that is a neural network model that randomly selects some of utterance feature sequences that are sequences of utterance features corresponding to respective utterances of a target speaker and replaces the selected utterance feature sequences with predetermined masking information to mask the utterance feature sequences, and estimates utterance features of the masked utterance feature sequences, and output the trained utterance feature reconstruction model as an unsupervised pre-trained model.

### TECHNICAL FIELD

The present disclosure relates to a model learning apparatus that trains a pre-trained model, a satisfaction estimation apparatus that estimates a conversation satisfaction level and an utterance satisfaction level on the basis of an estimation model trained by a pre-trained model, a model learning method, a satisfaction estimation method, and a program.

### BACKGROUND ART

There is a demand for technology for, in a conversation, estimating a satisfaction level (hereinafter referred to as a “conversation satisfaction level”) of a target speaker with respect to the entire conversation and a satisfaction level (hereinafter referred to as an “utterance satisfaction level”) of the target speaker for each utterance of the target speaker. A satisfaction level is a stepwise category indicating whether a speaker expresses satisfaction or dissatisfaction, and indicates, for example, three stages of satisfaction, normality, and dissatisfaction. The most typical application of this technology is an application in which a conversation is a call center call and a target speaker is a customer, that is, estimation of a customer satisfaction level in the call center call. For example, it is possible to automate operator evaluation by totaling estimation results of conversation satisfaction levels of customers for each operator, and it is also possible to analyze issues of services by collecting only utterance sections with utterance satisfaction levels of “dissatisfaction”, performing voice recognition, and performing text analysis. Note that such technology is not limited to only call center cells and can be applied to general face-to-face or non-face-to-face conversations among a plurality of speakers.

Patent Literature 1 discloses a technique for estimating a conversation satisfaction level and an utterance satisfaction level from a conversation (hereinafter referred to as a conventional technique). In the conventional technique, a feature vector (hereinafter referred to as an utterance feature amount) including one or more of a prosody feature, a conversation feature, and a linguistic feature is extracted for each utterance of a target speaker, and then input to a model that simultaneously estimates an utterance satisfaction level and a conversation satisfaction level, thereby obtaining estimation results of the utterance satisfaction level and the conversation satisfaction level. The point of the conventional technique is to obtain an estimation model that improves the estimation accuracy of an utterance satisfaction level and a conversation satisfaction level by hierarchically performing multi-task learning using the relationship between the utterance satisfaction level and the conversation satisfaction level.

### CITATION LIST

### Patent Literature

Patent Literature 1: Japanese Patent No. 6852161

### SUMMARY OF INVENTION

### Technical Problem

As the estimation model of the conventional technique, for example, an estimation model based on a deep neural network such as a recurrent neural network (RNN) is used. A large amount of labeled learning data is required to train this estimation model. Training data represents a set of labels representing true values of input features and information to be estimated, and in the conventional technique, refers to a sequence of utterance feature amounts in a certain conversation, a true value sequence of utterance satisfaction levels in the conversation, and true values of conversation satisfaction levels.

However, in order to prepare a large amount of labeled learning data, a very large cost is incurred. This is because a true value sequence of utterance satisfaction levels and true values of conversation satisfaction levels require a person to listen to a conversation and manually assign labels of the true values. Therefore, in practice, the estimation model needs to be trained from a small amount of labeled learning data. However, in that case, the estimation accuracy of an utterance satisfaction level and a conversation satisfaction level may be low.

Therefore, an object of the present disclosure is to provide an unsupervised pre-trained model learning apparatus for constructing a highly accurate estimation model with a small amount of labeled learning data.

### Solution to Problem

A model learning apparatus of the present disclosure includes an utterance feature reconstruction model learning unit.

An utterance feature reconstruction model learning unit trains an utterance feature reconstruction model that is a neural network model that randomly selects some of utterance feature sequences that are sequences of utterance features corresponding to respective utterances of a target speaker and replaces the selected utterance feature sequences with predetermined masking information to mask the utterance feature sequences, and estimates utterance features of the masked utterance feature sequences, and outputs the trained utterance feature reconstruction model as an unsupervised pre-trained model.

### Advantageous Effects of Invention

According to the model learning apparatus of the present disclosure, it is possible to obtain a pre-trained model for constructing a highly accurate estimation model with a small amount of labeled learning data.

### BRIEF DESCRIPTION OF DRAWINGS

FIG. 1 is a block diagram illustrating functional configurations of a model learning apparatus and a satisfaction estimation apparatus according to example 1.

FIG. 2 is a diagram illustrating structures of an encoder and a decoder used for model learning.

FIG. 3 is a flowchart illustrating an utterance feature reconstruction model learning operation of the model learning apparatus of example 1.

FIG. 4 is a flowchart illustrating a satisfaction level estimation model learning operation of the model learning apparatus of example 1.

FIG. 5 is a flowchart illustrating a satisfaction level estimation operation of the model learning apparatus of example 1.

FIG. 6 is a graph showing results of experiments of comparing the performances of the devices of the conventional technique and example 1.

FIG. 7 is a graph showing results of experiments of comparing the performances of the devices of the conventional technique and example 1.

FIG. 8 is a diagram illustrating a functional configuration example of a computer.

### DESCRIPTION OF EMBODIMENTS

Hereinafter, embodiments of the present disclosure will be described in detail. Note that components having the same function are denoted by the same reference numerals, and redundant description will be omitted.

Note that, in examples, it is assumed that the utterance of each speaker included in a conversation is recorded in a different channel for each speaker, and the channel of a target speaker is known. For example, in the case of a contact center call and a target speaker corresponding to a customer, it is assumed that the customer and an operator are recorded on different channels, and the channel of the customer is known.

### Example 1

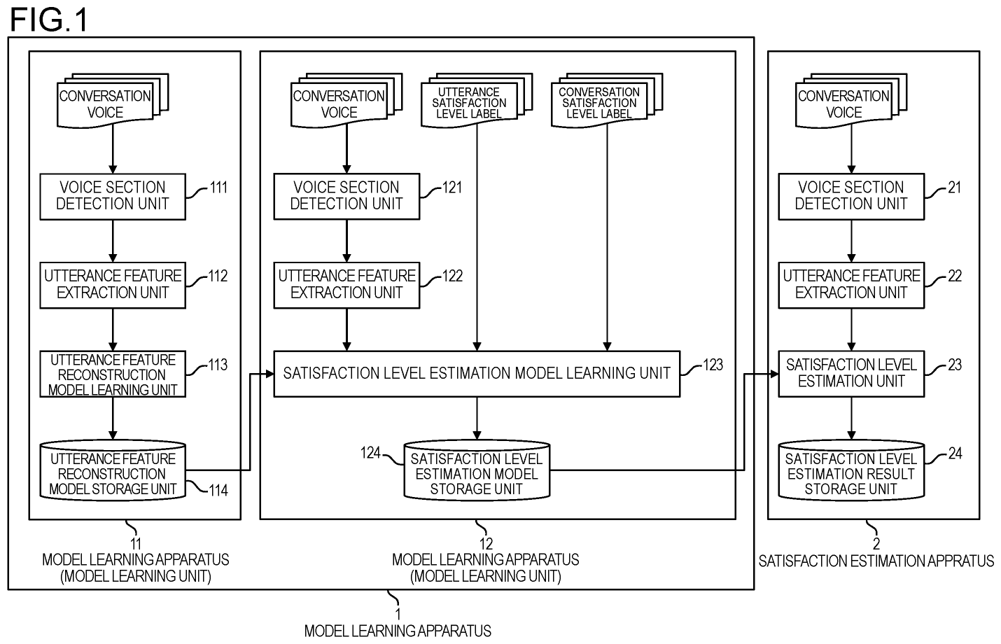

Functional configurations of a model learning apparatus and a satisfaction estimation apparatus according to example 1 will be described with reference to FIG. 1. As illustrated in the figure, the model learning apparatus 1 of the present example includes a model learning unit 11 that trains a model (utterance feature reconstruction model) for performing reconstruction of utterance features, and a model learning unit 12 that trains a satisfaction level estimation model on the basis of the utterance feature reconstruction model. Note that the model learning unit 11 and the model learning unit 12 may be configured as individual devices. In this case, they are referred to as the model learning apparatus 11 and the model learning apparatus 12. The model learning unit 11 (model learning apparatus 11) includes a voice section detection unit 111, an utterance feature extraction unit 112, an utterance feature reconstruction model learning unit 113, and an utterance feature reconstruction model storage unit 114. The model learning unit 12 (model learning apparatus 12) includes a voice section detection unit 121, an utterance feature extraction unit 122, a satisfaction level estimation model learning unit 123, and a satisfaction level estimation model storage unit 124. A satisfaction estimation apparatus 2 includes a voice section detection unit 21, an utterance feature extraction unit 22, a satisfaction level estimation unit 23, and a satisfaction level estimation result storage unit 24.

### <Model Learning Unit 11 (Model Learning Apparatus 11)>

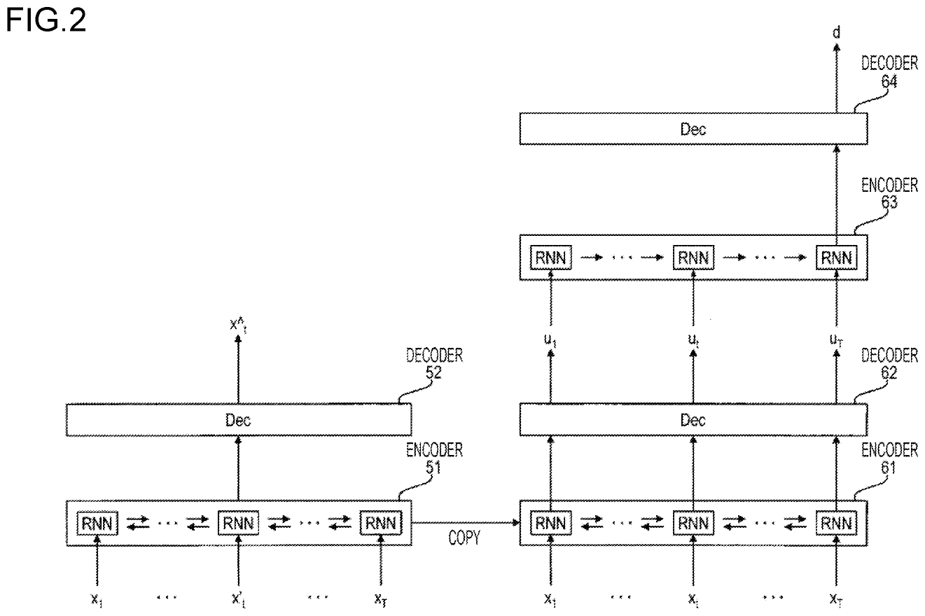

First, as a first stage, the model learning unit 11 (model learning apparatus 11) trains a model for performing reconstruction of utterance features using a large amount of unlabeled conversation data. As illustrated in FIG. 2, the model for performing reconstruction of the utterance features includes blocks of an encoder 51 (RNN) used for estimation of an utterance satisfaction level in the conventional technique and blocks of a decoder 52 that performs reconstruction of utterance features using the output of the layer. Note that x₁, . . . , xₜ, . . . , x_{T} represent utterance feature amounts of the first, . . . t-th, . . . , T-th utterances of a target speaker, the utterance feature amount of the t-th utterance is assumed to be masked, and the masked utterance feature amount is denoted as x′ₜ by attaching “′” thereto. x\hat{ }ₜ represents an estimated utterance feature amount of a masked target speaker.

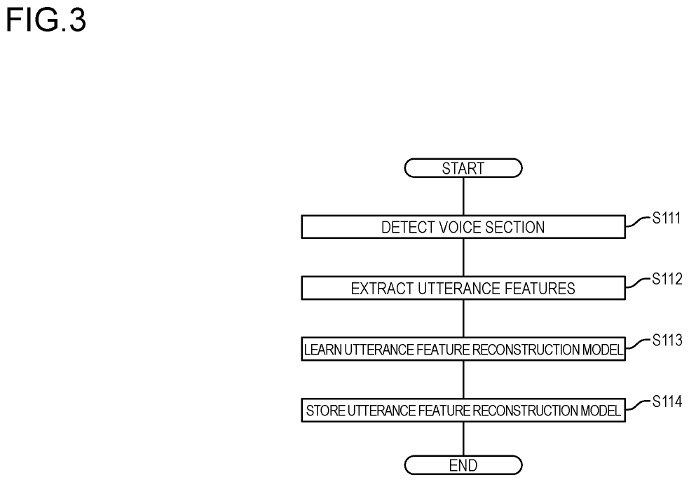

According to learning in the first stage, a block used to estimate an utterance satisfaction level, which is a lower layer portion of the model for reconstructing utterance features, can obtain the tendency of ease of expression of a sequence of utterance feature amounts in a conversation (for example, in many conversations, it is possible to train that the pitch of customer's voice among prosody features rarely changes abruptly). Hereinafter, the operation of each component in the model learning unit 11 (model learning apparatus 11) will be described with reference to FIG. 3.

### <<Voice Section Detection Unit 111>>.

Input: conversation vocal sound.
Output: utterance sequence and utterance time information

The voice section detection unit 111 acquires conversation vocal sound, executes voice section detection on each channel of the conversation vocal sound, and outputs an utterance sequence that is a sequence of utterances of each speaker included in the conversation and utterance time information of each utterance (S111). The utterance time information refers to the start/end time of each utterance viewed from the start of the conversation. Although a method based on power threshold processing is used for voice section detection in the present embodiment, another voice section detection method such as a method based on a likelihood ratio of voice/non-voice models may be used.

### <<Utterance Feature Extraction Unit 112>>

Input: utterance sequence and utterance time information
Output: utterance feature sequence

The utterance feature extraction unit 112 acquires an utterance sequence and utterance time information, extracts an utterance feature corresponding to each utterance of a target speaker, and outputs an utterance feature sequence that is a sequence of utterance features (S112). For example, an utterance feature may be any one or more of a prosody feature, a conversation feature, and a linguistic feature.

As the prosodic feature, at least one of a mean, a standard deviation, a maximum value, and a minimum value of a fundamental frequency and a power in utterances of the target speaker, a speech speed in an utterance of the target speaker, and a duration of a final phoneme in an utterance of the target speaker are used. Here, it is assumed that an utterance is divided into frames and the fundamental frequency and power are obtained for each of the frames. In a case where the speech speed and the duration of the final phoneme are used, a phoneme sequence in utterance is assumed to be estimated using voice recognition.

As conversation features, at least one of a time from an immediately previous utterance of the target speaker, a period from an immediately previous utterance of a non-target speaker to an utterance of the target speaker, a period from an utterance of the target speaker to an immediately subsequent utterance of the non-target speaker, the length of an utterance of the target speaker, the lengths of previous and subsequent utterances of the non-target speaker, the number of responses of the target speaker presented during previous and subsequent utterances of the non-subject speaker, and the number of responses of the non-subject speaker presented during an utterance of the target speaker is used.

As the language feature, at least one of the number of words in an utterance of the target speaker, the number of fillers in an utterance of the target speaker, and the number of appearances of words of gratitude in an utterance of the target speaker is used. In a case where the linguistic feature is used, words appearing in an utterance are estimated using voice recognition, and a result thereof is used. In addition, it is assumed that words of gratitude are manually selected, and for example, the number of appearances of “thank you” or “thanks” is obtained.

### <<Utterance Feature Reconstruction Model Learning Unit 113>>

Input: utterance feature sequence.
Output: utterance feature reconstruction model (unsupervised pre-trained model)

The utterance feature reconstruction model learning unit 113 trains an utterance feature reconstruction model as a neural network model that acquires an utterance feature sequence, randomly selects some utterance feature sequences corresponding to utterances of the target speaker, and replaces the selected utterance feature sequences with predetermined masking information to mask them, and estimates utterance features of the masked utterance feature sequences, and outputs the trained utterance feature reconstruction model as an unsupervised pre-trained model (S113).

Masking refers to processing of replacing a feature amount with a vector having another value with the same number of dimensions, and for example, refers to making the feature amount a zero vector. The masked utterance feature amount is used as an input, and parameters of the model for reconstructing utterance features such that the utterance feature amount of the masked portion is estimated are updated.

It is preferable that the utterance feature reconstruction model learning unit 113 randomly select utterance feature sequences and randomly mask some utterance feature amounts from among the selected utterance feature sequences. For example, after randomly selecting portions to be masked, the utterance feature reconstruction model learning unit 113 replaces 80% of all portions with a zero vector, replaces 10% with utterance features of another random portion included in the conversation, and does not replace 10%. Further, it is preferable that portions to be masked be utterance features of at most 20% of the entire conversation. The proportion of portions to be masked and the masking method may be changed or deleted, and for example, masking may be performed by replacing the portions with an average value of utterance characteristics in the entire conversation.

For example, a decoder based on a long short-term memory recurrent neural network (LSTM-RNN) and a fully connected layer can be used as the utterance feature reconstruction model. Here, a neural network layer other than the fully connected layer and the LSTM-RNN may be used, and for example, a gated recurrent unit may be used instead of the LSTM-RNN.

Back Propagation Through Time, which is an existing neural network learning method, is used for model learning. Although L1 norm of a feature amount is used as a loss function, another distance measure (for example, L2 norm) may be used.

### <<Utterance Feature Reconstruction Model Storage Unit 114>>.

Input: utterance feature reconstruction model.
Output: utterance feature reconstruction model

The utterance feature reconstruction model storage unit 114 stores the utterance feature reconstruction model trained and output in step S113, and outputs the stored utterance feature reconstruction model in response to a request from the model learning unit 12 (model learning apparatus 12) (S114).

### <Model Learning Unit 12 (Model Learning Apparatus 12)>

In the second stage, the model learning unit 12 (model learning apparatus 12) trains an estimation model (satisfaction level estimation model) for estimating an utterance satisfaction level and a conversation satisfaction level using a small amount of labeled learning data. As illustrated in FIG. 2, the satisfaction level estimation model includes blocks of an encoder 61 (RNN) used to estimate an utterance satisfaction level, blocks of a decoder 62 using an output of a layer of the encoder 61, blocks of an encoder 63 (RNN) used to estimate a conversation satisfaction level, and blocks of a decoder 64 using an output of a layer of the encoder 63. Note that u₁, . . . , uₜ, u_{T} represent utterance satisfaction levels of the first, . . . , t-th, . . . , T-th utterances of the target speaker, and d represents a conversation satisfaction level.

As a model parameter initial value of the encoder 61 used to estimate an utterance satisfaction level in the estimation model, a learned parameter of the encoder 51 obtained by learning in the first stage is used. Although a method similar to the conventional method is used for updating parameters, at this time, a learning rate is lowered (for example, to 1/10 of the conventional technique in which pre-learning is not performed) and update is performed. Accordingly, learning of the estimation model proceeds to estimate an utterance satisfaction level and a conversation satisfaction level while considering the ease of appearance of a sequence of utterance feature amounts in a conversation. As a result, even in a case where a small amount of labeled learning data is used, it is possible to obtain an estimation model capable of estimating an utterance satisfaction level and a conversation satisfaction level with high accuracy (for example, in a case where the pitch of the vocal sound of a target speaker has rapidly changed in an utterance with an utterance satisfaction level of “satisfaction,” there is a possibility that it is difficult to link the rapid change in the pitch of the vocal sound of the target speaker and the estimation result of “satisfaction” using only a small amount of learning data, but it is easy to link the change and the estimation result of “satisfaction” since the model characterized in that a rapid change is rare is obtained by performing the first stage learning).

Note that such an approach of using unlabeled data for pre-learning is called unsupervised pre-learning, and effectiveness has been confirmed in fields of natural language processing and image processing (Reference Non Patent Literature 1 and 2). However, there is no example of using unsupervised pre-learning for the purpose of estimating an utterance satisfaction level and a conversation satisfaction level of a target speaker in a conversation, and there is no example of using unsupervised pre-learning for heuristic feature amounts such as prosody features, conversation features, and linguistic features.
(Reference Non Patent Literature 1: Ting Chen and Simon Kornblith and Mohammad Norouzi and Geoffrey Hinton, “A Simple Framework for Contrastive Learning of Visual Representations”, Proc. ICML, pp. 1597-1607, 2020.)
(Reference Non Patent Literature 2: Jacob Devlin, Ming-Wei Chang, Kenton Lee and Kristina Toutanova, “BERT: Pre-learning of Deep Bidirectional Transformers for Language Understanding”, Proc. of NAACL-HLT, pp. 4171-4186, 2019.)

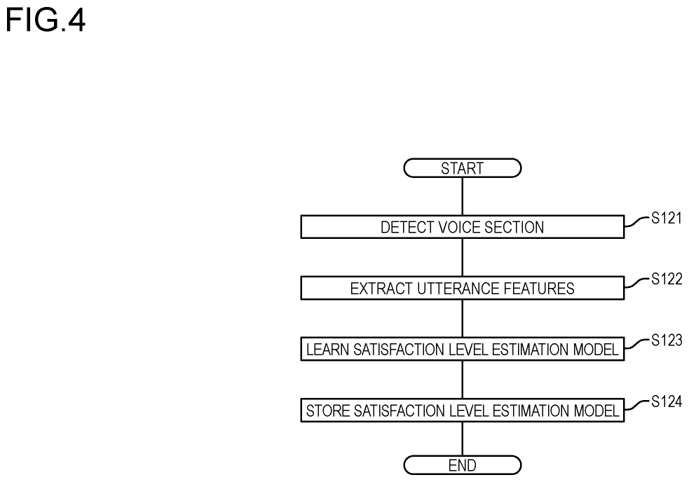

Hereinafter, the operation of each component in the model learning unit 12 (model learning apparatus 12) will be described with reference to FIG. 4.

### <<Voice Section Detection Unit 121>>

Input: conversation vocal sound.
Output: utterance sequence and utterance time information

The voice section detection unit 121 executes processing similar to that of the voice section detection unit 111 (S121). However, the conversation vocal sound detected in a voice section is data to which labels of an utterance satisfaction level and a conversation interactive satisfaction level have been attached.

### <<Utterance Feature Extraction Unit 122>>.

Input: utterance sequence and utterance time information.
Output: utterance feature sequence

The utterance feature extraction unit 122 executes processing similar to that of the utterance feature extraction unit 112 on the basis of the utterance sequence and the utterance generation time information output in step S121 (S122).

### <<Satisfaction Level Estimation Model Learning Unit 123>>

Input: utterance feature sequence, utterance satisfaction level label, conversation satisfaction level label, and utterance feature reconstruction model.
Output: satisfaction level estimation model

The satisfaction level estimation model learning unit 123 performs supervised learning on a satisfaction level estimation model that is a model for estimating an utterance satisfaction level and a conversation satisfaction level using parameters of an utterance feature reconstruction model as initial values of model parameters and using an utterance feature sequence and a corresponding utterance satisfaction level label and conversation satisfaction level label as learning data (S123).

In the present example, an LSTM-RNN or a fully connected layer is used as the satisfaction level estimation model. At this time, in order to train the satisfaction level estimation model using the parameters of the utterance feature reconstruction model as initial values, it is assumed that, in the utterance feature reconstruction model and the utterance satisfaction level and conversation satisfaction level estimation model, utterance satisfaction level estimation parts use an LSTM-RNN having the same number of hidden layers and the same number of units.

The model learning method is similar to the conventional method. That is, model parameters are updated by performing error back propagation of a loss error obtained by the weighted sum of estimated loss errors of an utterance satisfaction level and a conversation satisfaction level. However, parameter update is performed with a low learning rate (for example, α=0.0001 when Adam is used as an optimization method) such that parameters learned by the utterance feature reconstruction model are not significantly changed.

### <<Satisfaction Level Estimation Model Storage Unit 124>>.

Input: satisfaction level estimation model.
Output: satisfaction level estimation model The satisfaction level estimation model storage unit 124 stores the satisfaction level estimation model trained and output in step S123 and outputs the stored satisfaction level estimation model in response to a request from the satisfaction estimation apparatus 2 (S124).

### <Satisfaction Level Estimation Device 2>

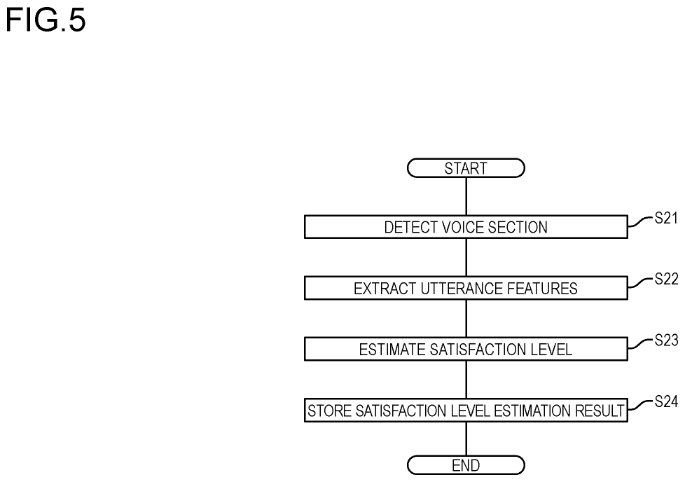

The satisfaction estimation apparatus 2 estimates an utterance satisfaction level and a conversation satisfaction level on the basis of the satisfaction level estimation model trained in the second stage. Hereinafter, the operation of each component in the satisfaction estimation apparatus 2 will be described with reference to FIG. 5.

### <<Voice Section Detection Unit 21>>.

Input: conversation vocal sound
Output: utterance sequence and utterance time information

The voice section detection unit 21 executes processing similar to that of the voice section detection unit 111 and the voice section detection unit 121 (S21). However, the conversation vocal sound detected in a voice section is a conversation vocal sound of a satisfaction level estimation target.

### <<Utterance Feature Extraction Unit 22>>

Input: utterance sequence and utterance time information
Output: utterance feature sequence

The utterance feature extraction unit 22 executes processing similar to that of the utterance feature extraction unit 112 and the utterance feature extraction unit 122 on the basis of the utterance sequence and the utterance generation time information output in step S21 (S22).

### <<Satisfaction Level Estimation Unit 23>>

Input: utterance feature sequence, utterance satisfaction level, and satisfaction level estimation model (in the case of a configuration in which a model is stored in the satisfaction estimation apparatus 2, the model is input only for the first time.)
Output: estimation result sequence of utterance satisfaction level and estimation result of conversation satisfaction level

The satisfaction level estimation unit 23 estimates an utterance satisfaction level and a conversation satisfaction level on the basis of the satisfaction level estimation model trained in the second stage, acquires an estimation result sequence of the utterance satisfaction level and an estimation result of the conversation satisfaction level, and outputs the estimation results (S23). The satisfaction level estimation unit 23 inputs an utterance feature sequence to the satisfaction level estimation model and performs forward propagation to simultaneously acquire an estimation result sequence of the utterance satisfaction level and an estimation result of the conversation satisfaction level.

### <<Satisfaction Level Estimation Result Storage Unit 24>>

Input: estimation result sequence of utterance satisfaction level and estimation result of conversation satisfaction level
Output: estimation result sequence of utterance satisfaction level and estimation result of conversation satisfaction level

The satisfaction level estimation result storage unit 24 stores the estimation result sequence of the utterance satisfaction level and the estimation result of the conversation satisfaction level output in step S23, and outputs the stored estimation result sequence of the utterance satisfaction level and estimation result of the conversation satisfaction level in response to a request from an arbitrary device (S24).

In the above disclosure, the method disclosed in Patent Literature 1 can be cited except that the parameters of the encoder part of the model are changed to those obtained by performing labeled learning on the basis of the pre-trained model.

However, any method may be used as long as it is a method of estimating an utterance satisfaction level or a conversation satisfaction level from an utterance feature sequence, and a specific method is not limited to Patent Literature 1.

For example, even in the case of a model other than the model for estimating an utterance satisfaction level and a conversation satisfaction level in two stages, if the model performs similar processing with the same input as that of Patent Literature 1, initial parameters according to the above-described pre-trained model have an effect.

In particular, for an inference model corresponding to the following two points, the initial parameters according to the pre-trained model described above has an effect.
Extracting a feature amount in units of utterances of a target speaker.
The model performs inference on either an utterance sequence of the target speaker or the entire call.

As another example in which the initial parameters according to the pre-trained model is effective, for example, there is Cold Anger detection or the like.

### <Evaluation Experiment>

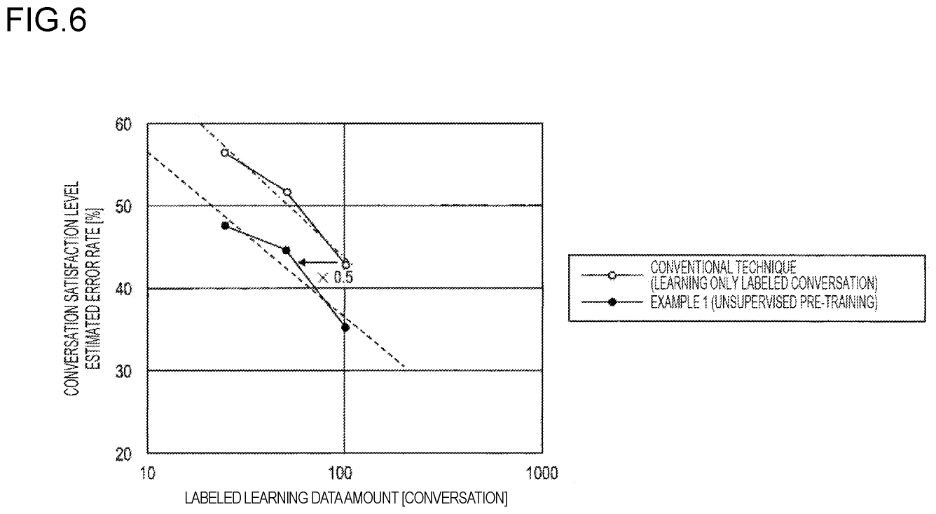

FIG. 6 illustrates a comparison between the relationship between an estimated error rate of a conversation satisfaction level by a model trained by the model learning apparatus 1 and the amount of labeled learning data and the relationship between an estimated error rate of a conversation satisfaction level by the model of the conventional technique (a model trained using only labeled learning data) and the amount of labeled learning data. From the figure, it can be ascertained that the model learning apparatus 1 of the present example has achieved the same true accuracy as that of the conventional technique even when the amount of labeled learning data has been reduced by 50%.

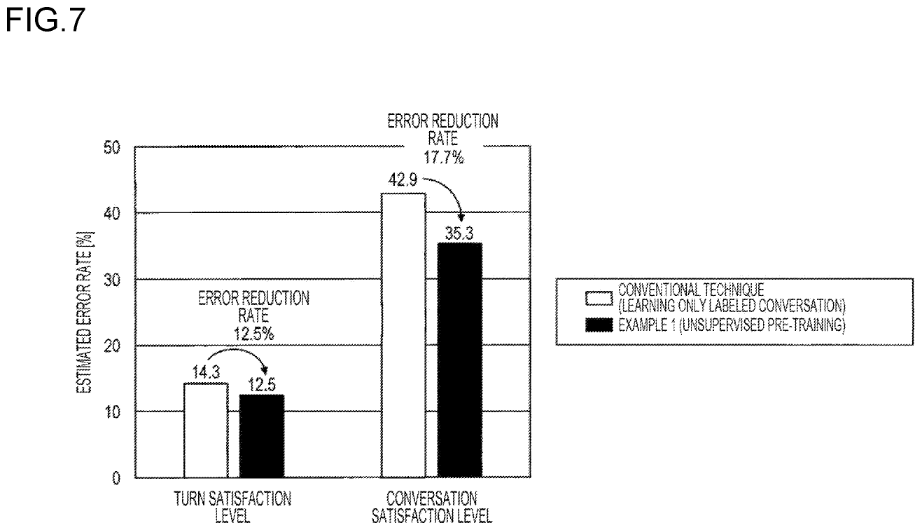

FIG. 7 illustrates comparison between estimated error rates of an utterance satisfaction level and a conversation satisfaction level by a model trained by the model learning apparatus 1 and estimated error rates of an utterance satisfaction level and a conversation satisfaction level by the model of the conventional technique (a model trained using only labeled learning data) on the assumption that the amount of labeled learning data is the same as that of the conventional technique. From the figure, it can be ascertained that, in a case where the amount of labeled learning data is the same as that in the conventional technique, the model learning apparatus 1 can reduce an estimated error rate of an utterance satisfaction level/conversation satisfaction level of the conventional technique by 10% or more.

### Effects

The model learning apparatus 1 and the satisfaction estimation apparatus 2 of example 1 are characterized in that pre-learning of an estimation model is performed using unlabeled conversations, and according to this characteristic, a highly accurate estimation model can be obtained even when a small amount of labeled learning data is used. Accordingly, for example, it is possible to provide an application (for example, automation of operator evaluation at a call center) for which estimation of an utterance satisfaction level and a conversation satisfaction level is required at low cost with high reliability.

The model learning apparatus 1 and the satisfaction estimation apparatus 2 of example 1 have an additional element of using a pre-trained model with respect to a conventional system such as Patent Literature 1, and this additional element enumerates a specific method of reducing the amount of labeled learning data required or reducing an estimated error rate in the same amount of labeled learning data with respect to the conventional system, and as a result, provides reduction in the amount of computations using a computer and improvement of the estimation accuracy by the computer.

### Supplements

For example, the device of the present disclosure includes, as a single hardware entity, an input unit to which a keyboard or the like is connectable, an output unit to which a liquid crystal display or the like is connectable, a communication unit to which a communication device (for example, a communication cable) capable of communicating with the outside of the hardware entity is connectable, a central processing unit (CPU which may include a cache memory, a register, or the like), a RAM and a ROM as memories, an external storage device as a hard disk, and a bus that connects the input unit, the output unit, the communication unit, the CPU, the RAM, the ROM, and the external storage device such that data can be exchanged. Furthermore, if necessary, a device (drive) or the like that can read and write a recording medium such as a CD-ROM may be provided in the hardware entity. Examples of a physical entity including such hardware resources include a general-purpose computer.

The external storage device of the hardware entity stores a program necessary to realize the above-described functions, data necessary for processing of the program, and the like (which is not limited to the external storage device, for example, the program may be stored in a ROM that is a read-only storage device.). In addition, data or the like obtained by processing of such a program is appropriately stored in a RAM, an external storage device, or the like.

In the hardware entity, each program stored in an external storage device (or a ROM or the like) and data necessary for processing of each program are read into a memory as necessary, and interpreted, executed and processed by the CPU as appropriate. As a result, the CPU realizes a predetermined function (each configuration requirement represented as above . . . unit, . . . means, etc.).

The present disclosure is not limited to the above-described embodiment, and modifications can be made without departing from the gist of the present disclosure. In addition, the processing described in the above embodiment may be executed not only in chronological order according to the described order, but also in parallel or individually according to the processing capability of the device that executes processing or as necessary.

As described above, in a case where the processing function in the hardware entity (the device of the present disclosure) described in the above embodiment is realized by a computer, the processing details of the function that the hardware entity should have is described by a program. Then, by executing this program on a computer, the processing function in the hardware entity is realized on the computer.

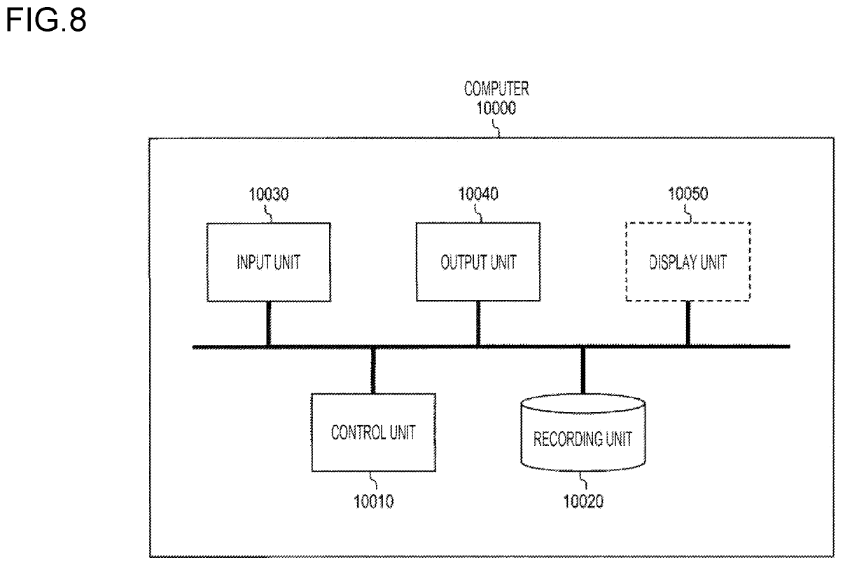

The above-described various types of processing can be performed by causing a recording unit 10020 of a computer 10000 illustrated in FIG. 8 to read a program for executing each step of the method described above and causing a control unit 10010, an input unit 10030, an output unit 10040, and the like to operate.

The program in which the processing details are written may be recorded on a computer-readable recording medium. The computer-readable recording medium may be any recording medium such as a magnetic recording device, an optical disk, a magneto-optical recording medium, or a semiconductor memory, for example. Specifically, for example, a hard disk device, a flexible disk, a magnetic tape, or the like can be used as a magnetic recording device, a digital versatile disc (DVD), a random access memory (DVD-RAM), a compact disc read only memory (CD-ROM), a CD-recordable (R)/rewritable (RW), or the like can be used as an optical disk, a magneto-optical disc (MO), or the like can be used as a magneto-optical recording medium, and an electrically erasable and programmable-read only memory (EEP-ROM) or the like can be used as a semiconductor memory.

Furthermore, distribution of this program is performed by, for example, selling, transferring, or renting a portable recording medium such as a DVD or a CD-ROM in which the program is recorded. Furthermore, this program may be stored in a storage device of a server computer, and the program may be distributed by transferring the program from the server computer to another computer via a network.

For example, a computer for executing such a program first temporarily stores a program recorded on a portable recording medium or a program transferred from a server computer in a storage device of the computer. Then, at the time of executing processing, the computer reads the program stored in its own recording medium, and executes processing according to the read program. In addition, as another form of executing the program, the computer may directly read the program from the portable recording medium and execute processing according to the program, and the computer may sequentially execute processing according to the received program each time the program is transferred from the server computer to the computer. In addition, the above-described processing may be executed by a so-called application service provider (ASP) type service that realizes a processing function only by an execution instruction and result acquisition without transferring the program from the server computer to the computer. Note that the program in the present form includes information used for processing by an electronic computer and equivalent to the program (data or the like that is not a direct command to the computer but has a property that defines processing of the computer).

Furthermore, in this form, the hardware entity is configured by causing a computer to execute a predetermined program, but at least a part of the processing details may be realized as hardware.

With regard to the above embodiments, the following supplements are further disclosed.

### (Supplement 1)

A model learning apparatus including:
a memory; and
at least one processor connected to the memory,
wherein the processor is configured to:
train an utterance feature reconstruction model that is a neural network model that randomly selects some of utterance feature sequences that are sequences of utterance features corresponding to respective utterances of a target speaker and replaces the selected utterance feature sequences with predetermined masking information to mask the utterance feature sequences, and estimates utterance features of the masked utterance feature sequences; and
output the trained utterance feature reconstruction model as an unsupervised pre-trained model.

### (Supplement 2)

A non-transitory storage medium storing a program executable by a computer to execute model learning processing, the model learning processing including:
learning an utterance feature reconstruction model that is a neural network model that randomly selects some of utterance feature sequences that are sequences of utterance features corresponding to respective utterances of a target speaker and replaces the selected utterance feature sequences with predetermined masking information to mask the utterance feature sequences, and estimates utterance features of the masked utterance feature sequences; and
outputting the trained utterance feature reconstruction model as an unsupervised pre-trained model.

### (Supplement 3)

The model learning apparatus according to supplement 1, wherein the processor performs supervised learning on a satisfaction level estimation model that is a model for estimating an utterance satisfaction level and a conversation satisfaction level by using parameters of the utterance feature reconstruction model as initial values of model parameters and using utterance feature sequences and corresponding utterance satisfaction level labels and conversation satisfaction level labels as learning data.

### (Supplement 4)

The non-transitory storage medium according to supplement 2, wherein the model learning processing includes performing supervised learning on a satisfaction level estimation model that is a model for estimating an utterance satisfaction level and a conversation satisfaction level by using parameters of the utterance feature reconstruction model as initial values of model parameters and using utterance feature sequences and corresponding utterance satisfaction level labels and conversation satisfaction level labels as learning data.

### (Supplement 5)

The model learning apparatus according to supplement 1, wherein the utterance features are any of prosody features, conversation features, and linguistic features.

### (Supplement 6)

The non-transitory storage medium according to supplement 2, wherein the utterance features are any of prosody features, conversation features, and linguistic features.

### (Supplement 7)

A satisfaction estimation apparatus including:
a memory; and
at least one processor connected to the memory,
wherein the processor is configured to estimate an utterance satisfaction level and a conversation satisfaction level corresponding to an utterance of a target speaker on the basis of a satisfaction level estimation model trained by using, as initial values of model parameters, parameters of an utterance feature reconstruction model that is a neural network model that randomly selects some of utterance feature sequences that are sequences of utterance features corresponding to respective utterances of a target speaker and replaces the selected utterance feature sequences with predetermined masking information to mask the utterance feature sequences, and estimates utterance features of the masked utterance feature sequences, and using utterance feature sequences and corresponding utterance satisfaction level labels and conversation satisfaction level labels as learning data.

### (Supplement 8)

A non-transitory storage medium storing a program executable by a computer to execute satisfaction level estimation processing, the satisfaction level estimation processing including estimating an utterance satisfaction level and a conversation satisfaction level corresponding to an utterance of a target speaker on the basis of a satisfaction level estimation model trained by using, as initial values of model parameters, parameters of an utterance feature reconstruction model that is a neural network model that randomly selects some of utterance feature sequences that are sequences of utterance features corresponding to respective utterances of a target speaker and replaces the selected utterance feature sequences with predetermined masking information to mask the utterance feature sequences, and estimates utterance features of the masked utterance feature sequences, and using utterance feature sequences and corresponding utterance satisfaction level labels and conversation satisfaction level labels as learning data.

1. A model learning apparatus comprising:
processing circuitry configured to
train an utterance feature reconstruction model that is a neural network model that randomly selects some of utterance feature sequences that are sequences of utterance features corresponding to respective utterances of a target speaker and replace the selected utterance feature sequences with predetermined masking information to mask the utterance feature sequences, and estimate utterance features of the masked utterance feature sequences; and
output the trained utterance feature reconstruction model as an unsupervised pre-trained model.

2. The model learning apparatus according to claim 1,
the processing circuitry configured to
perform supervised learning on a satisfaction level estimation model that is a model for estimating an utterance satisfaction level and a conversation satisfaction level by using parameters of the utterance feature reconstruction model as initial values of model parameters and using utterance feature sequences and corresponding utterance satisfaction level labels and conversation satisfaction level labels as learning data.

3. The model learning apparatus according to claim 1, wherein the utterance features are any of prosody features, conversation features, and linguistic features.

4. A satisfaction estimation apparatus comprising
processing circuitry configured to
estimate an utterance satisfaction level and a conversation satisfaction level corresponding to an utterance of a target speaker on the basis of a satisfaction level estimation model trained by using, as initial values of model parameters, parameters of an utterance feature reconstruction model that is a neural network model that randomly selects some of utterance feature sequences that are sequences of utterance features corresponding to respective utterances of a target speaker and replace the selected utterance feature sequences with predetermined masking information to mask the utterance feature sequences, and estimate utterance features of the masked utterance feature sequences, and using utterance feature sequences and corresponding utterance satisfaction level labels and conversation satisfaction level labels as learning data.

5. A model learning method executed by a model learning apparatus, the model learning method comprising a step of learning an utterance feature reconstruction model that is a neural network model that randomly selects some of utterance feature sequences that are sequences of utterance features corresponding to respective utterances of a target speaker and replaces the selected utterance feature sequences with predetermined masking information to mask the utterance feature sequences, and estimates utterance features of the masked utterance feature sequences, and outputting the trained utterance feature reconstruction model as an unsupervised pre-trained model.

6. A satisfaction estimation method executed by a satisfaction estimation apparatus, the satisfaction estimation method comprising a step of estimating an utterance satisfaction level and a conversation satisfaction level corresponding to an utterance of a target speaker on the basis of a satisfaction level estimation model trained by using, as initial values of model parameters, parameters of an utterance feature reconstruction model that is a neural network model that randomly selects some of utterance feature sequences that are sequences of utterance features corresponding to respective utterances of a target speaker and replaces the selected utterance feature sequences with predetermined masking information to mask the utterance feature sequences, and estimates utterance features of the masked utterance feature sequences, and using utterance feature sequences and corresponding utterance satisfaction level labels and conversation satisfaction level labels as learning data.

7. A non-transitory computer readable medium storing a computer program for causing a computer to function as the model learning apparatus according to claim 1.
